(19) United States
(12) Patent Application Publication
(10) Pub. No.: US 2004/0016141 A1
(43) Pub. Date: Jan. 29, 2004

(54) Method and system to measure distance travelled by a cart, buggy or trolley

(76) Inventor: Camiel Pieter Maria Hofstee, Laren (NL)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/418,723

(22) Filed: Apr. 18, 2003

(30) Foreign Application Priority Data
Jul. 24, 2002 (NL) NL 1021149

(51) Int. Cl. G01B 3/12

(52) U.S. Cl. 33/772

(57) ABSTRACT

A device and system that measures the distance over which a cart, buggy or trolley travels, and that can be mounted easily on a wheel of the cart, buggy or trolley, in particular a golf cart, buggy or trolley. The device includes a housing with a counterweight attached to the lower end of the housing and a measuring device inside the housing. The device further includes an attachment mechanism for attaching the housing to the wheel. The attachment mechanism includes a rotary shaft passing through the interior wall of the housing and rotatable in relation to the housing. The counterweight stops the housing of the measuring device from rotating with the wheel, while the rotary shaft of the measuring device rotates with the wheel. The measuring device consists of magnets in the rotary shaft which generate pulses from sensors mounted within the housing when the wheel turns. Electronic circuitry in the measuring device converts the pulses into a figure that can be displayed indicating the distance covered by the cart/buggy/trolley.

### CROSS REFERENCE TO RELATED APPLICATIONS

This application claims priority to and the benefit of application no. NL 1021149, filed Jul. 24, 2002.

### BACKGROUND OF THE INVENTION

1. Field of the Invention

The present invention concerns a device that is attached to the wheel of a cart, buggy or trolley for measuring the distance over which the cart, buggy or trolley travels, and in particular a golf cart, buggy or trolley.

2. Background

Existing systems involve counting the number of steps by the golfer or employ instruments that record speed whereby the twice-averaged speed provides a measure for the distance the golfer has travelled. Another method is based on radiographic systems that require a number of transmitters to be placed around the course. However, these systems have the disadvantage that they are inaccurate, expensive to make and cannot be used everywhere.

### SUMMARY OF THE INVENTION

The present invention provides a simple system of measuring distance that is also relatively accurate, can be used in any location and can be produced at a cost-effective price. The system consists of a housing, a device located within the housing for determining the distance over which a cart, buggy or trolley travels, and an attachment mechanism for mounting the housing easily on the wheel of the cart/buggy. The present invention has particular application to a golf cart, buggy or trolley to provide a device for determining the distance that a golfer travels in the course of a round, though its application is not limited to such.

The attachment mechanism includes a rotary shaft on which the housing is mounted. The rotary shaft is designed to rotate in relation to the housing along with the rotation of the wheel. In an exemplary embodiment, the attachment mechanism is mounted on the wheel in a manner which aligns the rotational axis of the rotary shaft with the rotational axis of the wheel.

The housing includes a counterweight positioned on the side of the housing closest to the ground. The counterweight serves to prevent the housing from rotating with the rotation of the rotary shaft. Thus, rotation of the wheel will cause the rotary shaft to rotate with the wheel in relation to the housing that does not rotate.

The distance determining device consists of a device that will sense the rotation of the rotary shaft in relation to the housing. In an exemplary embodiment, the distance determining device consists of one or more magnets positioned on the rotary shaft and one or more sensors positioned in the housing. When the rotary shaft rotates in relation to the housing, the sensors will sense the passing of a magnet generating a pulse from the sensor. The distance determining device further includes electronic circuitry that receives the pulses and determines the distance travelled based on the number of pulses sensed. The distance travelled can then be displayed on a display device associated with the electronic circuitry.

For the device to work properly, it has to be calibrated first just once.

The present invention is explained in greater detail below.

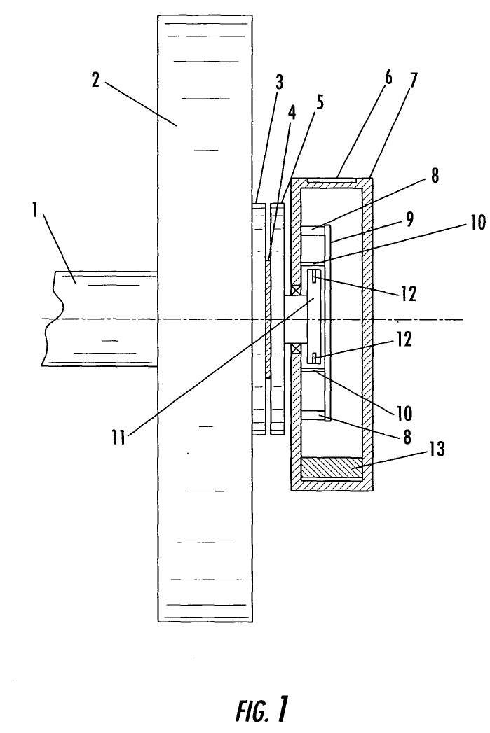

### BRIEF DESCRIPTION OF THE FIGURE FIG. 1 is a cross-sectional view of the present invention showing:

1—the axle of the cart/buggy/trolley

2—the wheel of the cart/buggy/trolley

3—the wheel attachment plate

4—the attachment mechanism

5—the distance measuring device's attachment plate

6—the LCD display

7—the housing for the distance measuring device

8—the printboard support

9—the print board

10—the sensors

11—the rotary shaft

12—the magnets on the rotary shaft

13—the counterweight

### DETAILED DESCRIPTION OF THE INVENTION

The present invention provides a method and a system to measure the distance over which a cart, buggy or trolley travels. The method and system works as follows.

Firstly, the wheel attachment plate (3) is attached to the wheel (2) of a cart, buggy or trolley (hereinafter “cart”). Then, the distance measuring device is coupled to the wheel attachment plate (3) by way of the attachment mechanism (4). This makes it easy to mount the distance measuring device on the cart, and it is just as simple to take it off again. For the operation of the mechanism, the housing (7) rotates in relation to the rotary shaft (11), which is fixed to the wheel (2) of the cart by way of the attachment mechanism (4).

Once the cart starts to move, the counterweight (13) will stop the housing (7) from rotating with the rotation of the wheel (2), while allowing the rotary shaft (11) with the magnets (12) to rotate with the wheel (2). This relative movement is recorded by the sensors (10) that will emit a pulse every time the magnets (12) pass by the sensors. The sensors (10) are connected to the print board (9) that, in turn, is attached to the housing (7) of the distance measuring device by way of the print board support (8). The embodiment illustrated uses two magnets and two sensors. It will be understood by one skilled in the art that a differing number of magnets and sensors may be used. The greater the number of magnets and sensors used, the greater and more exacting the device will be within one complete wheelturn for determining the distance travelled.

Electronic circuitry on the print board converts the pulses into a distance calculated based on the number of pulses generated by the sensors (10), which in turn is related to the number of rotations of the rotary shaft (11). This distance can then be displayed on the LCD display (6). By pushing a button (not shown), the distance readout can be reset to “0” (zero) and the next distance will be measured.

The first time that the device of the present invention is used, it should to be calibrated. This is done by pushing a function key (not shown in FIG. 1), moving the cart over a specified distance and then pushing the function key again. The electronic circuitry on the print board registers the number of pulses generated by the distance measuring device over the specified distance and uses this to calculate the distance covered each time the wheel completes a full rotation.

A distance measuring device produced in this fashion has the abovementioned properties (accurate and can be used anywhere), while it is cheap and easy to make at the same time. While the present invention has been disclosed in an exemplary form, it will be apparent to those skilled in the art that modifications can be made to this invention without departing from the spirit and scope of the invention.

I claim:

1. Distance measuring device for determining the distance travelled by a cart, buggy or trolley having a wheel comprising:
(a) a housing;
(b) a distance determining device associated with the housing; and
(c) an attachment mechanism to attach the housing to said wheel;
wherein the housing includes a device for preventing it from rotating with the rotation of said wheel and the measuring device determines the distance travelled based on the rotation of said wheel in relation to the housing.

2. Distance measuring device as recited in claim 1, wherein the attachment mechanism includes a rotary shaft on which the housing is mounted, the rotary shaft rotating with rotation of said wheel.

3. Distance measuring device as recited in claim 2, wherein the distance determining device includes at least one magnet associated with the rotary shaft and at least one sensor associated with the housing for sensing the rotation of the magnet with the rotation of the rotary shaft in relation to the housing.

4. Distance measuring device as recited in claim 3, wherein the sensor generates a pulse when the magnet passes by the sensor due to the rotation of the magnet in relation to the sensor.

5. Distance measuring device as recited in claim 4, wherein the measuring device further includes electronic circuitry for determining the distance travelled based on the number of pulses generated by the sensor.

6. Distance measuring device as recited in claim 1, wherein the attachment mechanism provides for easy attachment of the housing to said wheel.

7. Distance measuring device as recited in claim 1, wherein the housing further includes a display device for displaying the travelled distance determined by the measuring device.

8. Distance measuring device as recited in claim 1, wherein the attachment mechanism is attached to a golf cart, buggy or trolley.

9. Method for determining distance travelled by a cart, buggy or trolley having a wheel, comprising the steps of: (a) providing a housing; (b) providing a distance determining device associated with the housing; (c) providing an attachment mechanism to attach the housing to said wheel; further providing the housing with a device for preventing it from rotating with the rotation of said wheel, wherein the measuring device determines the distance travelled based on the rotation of said wheel in relation to the housing.

10. Method as recited in claim 9, the attachment mechanism further being provided with a rotary shaft on which the housing is mounted, the rotary shaft designed to rotate with rotation of said wheel, and the distance determining device being provided with at least one magnet associated with the rotary shaft and at least one sensor associated with the housing for sensing the rotation of the magnet with the rotation of the rotary shaft in relation to the housing.

11. Method as recited in claim 10, wherein the sensor generates a pulse when the magnet passes by the sensor due to the rotation of the magnet in relation to the sensor, and electronic circuitry is provided for determining the distance travelled based on the number of pulses generated by the sensor.

12. Method as recited in claim 9, further including the step of calibrating the distance determining device by moving said cart, buggy or trolley over a specified distance and determining the number of pulses generated by the sensor over the specified distance.

13. Method as recited in claim 9, further including the step of attaching the attachment mechanism to a wheel of a golf cart, buggy or trolley.
